(19) United States
(12) Patent Application Publication
(10) Pub. No.: US 2014/0316983 A1
(43) Pub. Date: Oct. 23, 2014

(54) SELECTIVELY ROUTING A TRANSACTION FROM AN AUTOMATED BANKING MACHINE BASED ON TRANSACTION PROCESSING FEES

(71) Applicant: Diebold Self-Service Systems division of Diebold, Incorporated, North Canton, OH (US)

(72) Inventors: James BLOCK, North Lawrence, OH (US); H. Thomas GRAEF, Bolivar, OH (US); Paul MAGEE, Troy, OH (US); Donald S. NELSON, JR., Akron, OH (US); James MEEK, North Canton, OH (US); Daniel McINTYRE, Uniontown, OH (US); Mark DEPIETRO, Canton, OH (US); Natarajan RAMACHANDRAN, Uniontown, OH (US)

(21) Appl. No.: 14/258,078

(22) Filed: Apr. 22, 2014

Related U.S. Application Data
(60) Provisional application No. 61/814,616, filed on Apr. 22, 2013.

(51) Int. Cl. G06Q 40/02

(52) U.S. Cl. CPC G06Q 40/02
USPC 705/43

(57) ABSTRACT

In an example embodiment, a routing computer is operable to communicate with an automated banking machine and with a plurality of remote financial transaction authorization systems. The routing computer is operable to receive data representative of a requested transaction associated with a financial account associated with a user operating the automated banking machine. The routing computer is operable to determine for the plurality of remote financial transaction authorization system a transaction processing fee for the requested transaction. The routing computer is operable to select a selected one of the plurality of remote financial transaction authorization systems for the transaction, wherein the selected one of the plurality of remote financial transaction systems is selected based on having the lowest transaction processing fee for the requested transaction.

### CROSS REFERENCE TO RELATED APPLICATIONS

This application claims the benefit under 35 U.S.C. §119 of U.S. Provisional Application No. 61/814,616, filed Apr. 22, 2013. The contents of the aforementioned application are hereby incorporated by reference in its entirety.

### TECHNICAL FIELD

The present disclosure relates generally to transactions performed employing automated banking machines.

### BACKGROUND

Automated banking machines, such as an automated teller machine (“ATM”) may include a card reader that operates to read data from a data bearing record such as a user card. Automated banking machines may operate to cause the data read from the card to be compared with other computer stored data related to the card bearer or the bearer's financial accounts. The machine operates in response to the comparison determining that the bearer record corresponds to an authorized user, to carry out at least one transaction which may be operative to transfer value to or from at least one account. A record of the transaction is also often printed through operation of the automated banking machine and provided to the user. Automated banking machines may be used to carry out transactions such as dispensing cash, the making of deposits, the transfer of funds between accounts, and account balance inquiries. The types of banking transactions that may be carried out are determined by the capabilities of the particular banking machine and system, as well as the programming of the institution operating the machine.

Other types of automated banking machines may be operated by merchants to carry out commercial transactions. These transactions may include, for example, the acceptance of deposit bags, the receipt of checks or other financial instruments, the dispensing of rolled coin, or other transactions required by merchants. For purposes of this disclosure an automated banking machine shall be deemed to include any machine that may be used to carry out transactions involving automated transfers of value, such as, for example, point of sale (“POS”) devices.

### BRIEF DESCRIPTION OF THE DRAWINGS

The accompanying drawings incorporated herein and forming a part of the specification illustrate the example embodiments.

FIG. 1 is a block diagram illustrating a banking system that employs a routing computer to selectively route transactions from an automated banking machine.

FIG. 2 is a block diagram illustrating an example of an automated banking machine.

FIG. 3 is a block diagram illustrating a computer system upon which an example embodiment can be implemented.

FIG. 4 is a block diagram illustrating an example methodology.

### OVERVIEW OF EXAMPLE EMBODIMENTS

The following presents a simplified overview of the example embodiments in order to provide a basic understanding of some aspects of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented later.

In accordance with an example embodiment, there is disclosed herein an apparatus that comprises a routing computer that is operable to communicate with an automated banking machine and with a plurality of remote financial transaction authorization systems. The routing computer is operable to receive data representative of a requested transaction associated with a financial account associated with a user operating the automated banking machine. The routing computer is operable to determine for the plurality of remote financial transaction authorization system a transaction processing fee for the requested transaction. The routing computer is operable to select a selected one of the plurality of remote financial transaction authorization systems for the transaction, wherein the selected one of the plurality of remote financial transaction systems is selected based on having the lowest transaction processing fee for the requested transaction.

In accordance with an example embodiment, there is disclosed herein an apparatus that comprises a routing computer operable to communicate with an automated banking machine and with a plurality of remote financial transaction authorization systems. The routing computer is operable to receive data representative of a requested transaction associated with a financial account associated with a user operating the automated banking machine. The routing computer is operable to determine for the plurality of remote financial transaction authorization system a transaction processing fee for the transaction. The routing computer is operable to select a selected one of the plurality of remote financial transaction authorization systems for the transaction, wherein the selected one of the plurality of remote financial transaction systems is selected based on performing the transaction without assessing a transaction processing fee.

In accordance with an example embodiment, there is disclosed herein Logic encoded in a tangible, non-transitory computer readable medium of instructions for execution by a processor, and when executed operable to communicate with an automated banking machine and with a plurality of remote financial transaction authorization systems. The logic is further operable to receive data representative of a requested transaction associated with a financial account associated with a user operating the automated banking machine. The logic is operable to determine for the plurality of remote financial transaction authorization system a transaction processing fee for the requested transaction. The logic is further operable to select a selected one of the plurality of remote financial transaction authorization systems for the transaction, wherein the selected one of the plurality of remote financial transaction systems is selected based on having the lowest transaction processing fee for the requested transaction.

### DESCRIPTION OF EXAMPLE EMBODIMENTS

This description provides examples not intended to limit the scope of the appended claims. The figures generally indicate the features of the examples, where it is understood and appreciated that like reference numerals are used to refer to like elements. Reference in the specification to “one embodiment” or “an embodiment” or “an example embodiment” means that a particular feature, structure, or characteristic described is included in at least one embodiment described herein and does not imply that the feature, structure, or characteristic is present in all embodiments described herein.

In an example embodiment, a user of the automated banking machine obtains data through a reader such as a card reader which is useful to identify the user's financial account. In another example embodiment, the reader may include an apparatus that can read data that is sent from a mobile wireless device such as a smart phone, a key fob, radio frequency identification (“RFID”) tag or other item that can provide to the automated machine, data that corresponds to a financial account.

In an example embodiment, a remote routing computer is operable to receive financial account and/or user data and a transaction request from the automated banking machines. The remote routing computer is operable to generate messages to selected numerous remote financial transaction authorization systems. In some example embodiments, the remote routing computer operates in accordance with its programming to route communications related to financial transactions to financial transaction authorization systems that can authorize and enable completion of the requested financial transaction at the automated banking machine in a manner that does not include an assessment of a transaction processing fee to the account of the user requesting the transaction, or to a financial transaction authorization system that charges the lowest transaction processing fee.

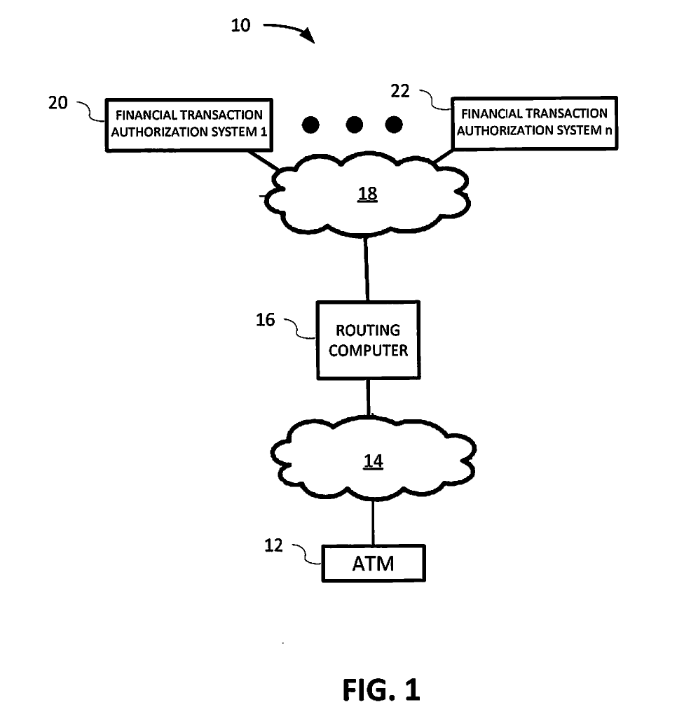

Referring now to the drawings and particularly FIG. 1, there is shown an example schematic representation of a banking system 10. It should be understood that while only a limited number of components of the banking system 10 may be shown, this is done merely for ease of illustration. In other example embodiments the banking system 10 may contain any physically realizable number of the same or different network components.

In an example embodiment an automated banking machine (in the illustrated example an ATM however those skilled in the art should readily appreciate that any type of automated banking machine can be employed) 12 is coupled to a communication network 14. The communication network 14 may extend within a banking office building or other facility, or may be distributed among a plurality of banking office buildings or facilities. In particular embodiments, the network 14 comprises a data transport network environment such as a packet-switched TCP/IP-based global communication network. The network 14 may comprise a number of network devices such as routers, bridges, gateways, firewalls and any other device that allows the network 14 to be operable to provide communications between connected devices and systems. The network 14 may suitably employ various message transport mechanisms such as, for example, Ethernet, Token-Ring™, 802.11, or other wire or wireless data communication mechanisms.

A routing computer 16 is coupled with the network 14. The routing computer is coupled to a financial transaction network 18 that is coupled with a plurality of Financial Transaction Authorization Systems 20, 22. Those skilled in the art should readily appreciate that in some embodiments, the ATM 12, Routing Computer 16, and plurality of Financial Transaction Authorization Systems 20, 22 may be coupled together on a single network. Moreover, in other embodiments, a plurality of financial transaction networks 18 may be coupled to routing computer 18 that enables routing computer to communicate with a plurality of Financial Transaction Authorization Systems 20, 22. In the illustrated example, n Financial Transaction Authorization Systems 20, 22 are illustrated, where n is an integer greater than one. Thus, the principles described herein should not be construed as limited by the illustrated arrangement of FIG. 1 as the illustrated arrangement of FIG. 1 was selected merely for ease of illustration of the example embodiments. 20, 22

In an example embodiment, logic in routing computer 16 is operable to communicate with the automated banking machine 12 and with a plurality of remote financial transaction authorization systems 20, 22. “Logic”, as used herein, includes but is not limited to hardware, firmware, software and/or combinations of each to perform a function(s) or an action(s), and/or to cause a function or action from another component. For example, based on a desired application or need, logic may include a software controlled microprocessor, discrete logic such as an application specific integrated circuit (ASIC), a programmable/programmed logic device, memory device containing instructions, or the like, or combinational logic embodied in hardware. Logic may also be fully embodied as software that when executed by a processor performs the described functionality.

The routing computer 16 is operable to receive data representative of a requested transaction associated with a financial account associated with a user operating the automated banking machine 12. The routing computer 16 is operable to determine a transaction processing fee for the requested transaction for the plurality of remote financial transaction authorization systems 20, 22. The routing computer 16 is operable to select a selected one of the plurality of remote financial transaction authorization systems 20, 22 for the transaction. The selected one of the plurality of remote financial transaction systems 20, 22 is selected based on having the lowest (or no) transaction processing fee for the requested transaction.

In an example embodiment, the routing computer 16 is operable to communicate with the automated banking machine 12 and the selected one of the plurality of remote financial transaction systems 20, 22 to perform the requested transaction. For example, the routing computer 16 may be operable to generate messages corresponding to financial transaction messages associated with the requested transaction. In particular embodiments, a plurality of transactions may be performed.

In an example embodiment, the data representative of a requested transaction associated with a financial account comprises an account number. In particular embodiments, the routing computer 16 is operable to determine institution data corresponding to a financial institution holding the financial account. The selection of the selected one of the plurality of remote financial transaction authorization systems 20, 22 for the transaction may be based at least in part on the institution data. For example, if more than one financial transaction authorization systems 20, 22 can perform the transaction at the lowest (or no) transaction fee, if the institution holding the account is one of financial transaction authorization systems 20, 22 that can perform the transaction at the lowest (or no) transaction fee, the institution holding the financial account may be selected.

In an example embodiment, the requested transaction is for a cash withdrawal. The routing computer 16 is operable to communicate with the automated banking system 12 and the selected one of the plurality of remote financial transaction systems 20, 22 to authorize the cash withdrawal.

In an example embodiment, the data representative of a requested transactions comprises data representative of a check cashing transaction that includes a check amount. The routing computer 16 is operable to communicate with the automated banking system 12 and the selected one of the plurality of remote financial transaction systems 20, 22 to cause the financial account to be credited with the check amount.

In an example embodiment, routing computer 16 is operable to receive data representative of a second requested transaction associated with a second financial account associated with a second user operating the automated banking machine 12. The routing computer 16 is operable to determine a transaction processing fee for the second requested transaction for the plurality of remote financial transaction authorization systems 20, 22. The routing computer 16 is operable to select a second of the plurality of remote financial transaction authorization systems 20, 22 (which may be the same remote financial transaction authorization system selected for the first transaction) for the second requested transaction. The selected second of the plurality of remote financial transaction systems 20, 22 can be selected based on having the lowest transaction processing fee for the second requested transaction. In particular embodiments, the routing computer 16 is operable to determine from the data representative of a second requested transaction a second account number for the second financial account and institution data corresponding to a second financial institution holding the second financial account. The selection of the selected second of the plurality of remote financial transaction authorization systems 20, 22 for the transaction can be based at least in part on the institution data.

In an example embodiment, the first requested transaction includes dispensing a first amount of cash having a first value, and the second requested transaction includes dispensing a second amount of cash having a second value. The first selected financial transaction system is operable to cause the first financial account to be assessed the first value, and the second selected financial transaction system is operable to cause the second financial account to be assessed the second value.

In an example embodiment, the receive data representative of a requested transactions comprises data representative of a cash deposit transaction that includes an amount. The routing computer 16 is operable to communicate with the automated banking system 12 and the selected one of the plurality of remote financial transaction systems 20, 22 to cause the financial account to be credited with the amount.

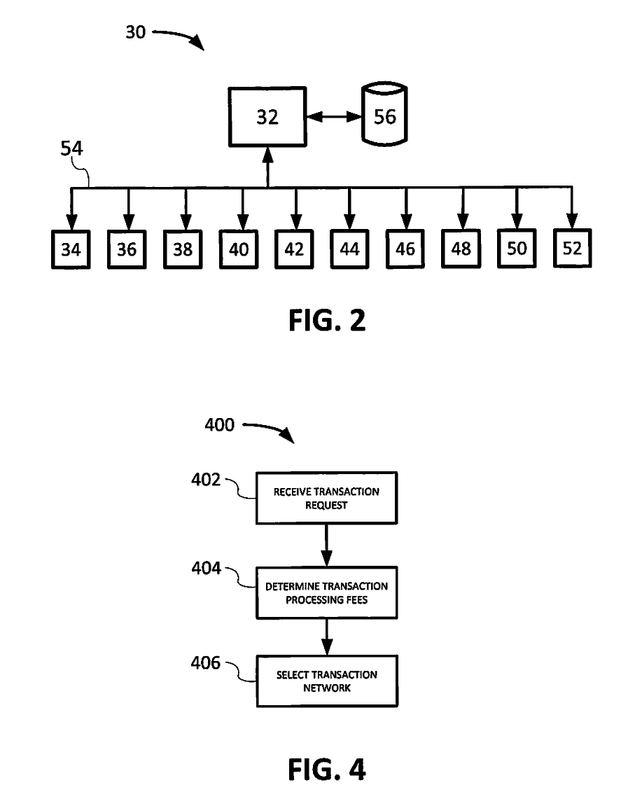

FIG. 2 is a block diagram illustrating an example of an automated banking machine 30. The automated banking machine 30 comprises a processor 32 that is coupled to a card reader 34, wireless reader 36, display 38, keypad 40, cash dispenser 42, cash acceptor 44, cash recycler 46 (which may employ components of cash dispenser 42 and/or cash acceptor 44), check acceptor 48, printer 50, communication interface 52 via bus 54. The processor 32 is also coupled to a data store 56 which may store instructions for operating the processor 32.

In an example embodiment, a user may approach the ATM 30. The user may use a card in conjunction with card reader 34 and/or a wireless device in conjunction with wireless reader 36 to allow the processor to authenticate the user and determine a financial account associated with the user. The processor 32 can employ display 38 and keypad 40 to determine the type of transaction the user desires. Data representative of the transaction request and the financial account (or accounts) associated with the request may be forwarded to a remote routing computer via communication interface 52. Upon approval of the transaction request, the processor 32 may receive cash and/or checks (or other financial documents) through cash acceptor 44 and check acceptor 44 respectively. Cash may dispensed via cash dispenser 42.

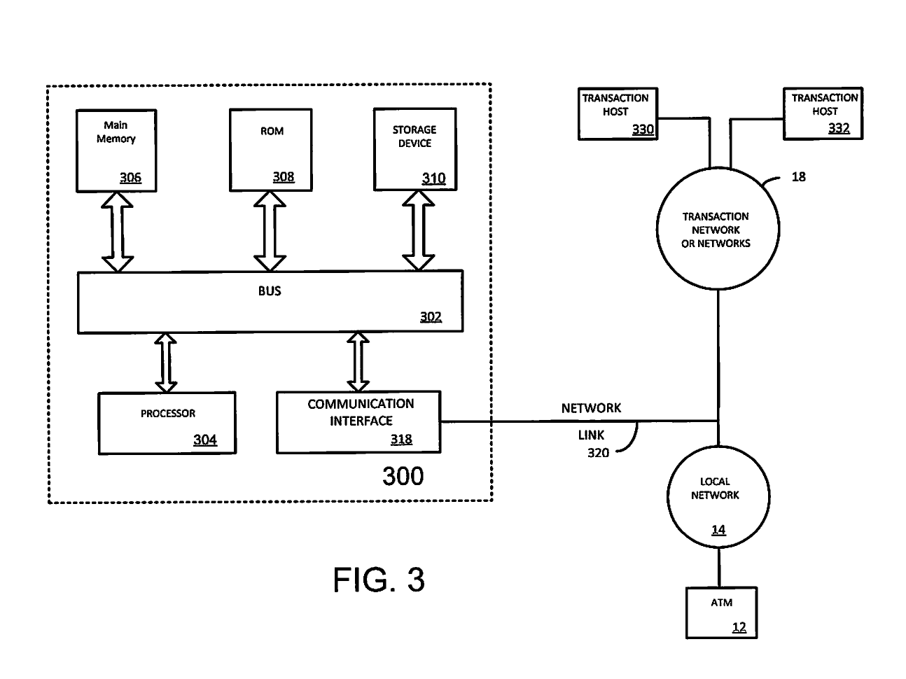

FIG. 3 is a block diagram illustrating a computer system upon which an example embodiment can be implemented. Computer system 300 is suitable for implementing the functionality of the logic described for routing computer 16 (FIG. 1).

Computer system 300 includes a bus 302 or other communication mechanism for communicating information and a processor 304 coupled with bus 302 for processing information. Computer system 300 also includes a main memory 306, such as random access memory (RAM) or other dynamic storage device coupled to bus 302 for storing information and instructions to be executed by processor 304. Main memory 306 also may be used for storing a temporary variable or other intermediate information during execution of instructions to be executed by processor 304. Computer system 300 further includes a read only memory (ROM) 308 or other static storage device coupled to bus 302 for storing static information and instructions for processor 304. A storage device 310, such as a magnetic disk or optical disk, is provided and coupled to bus 302 for storing information and instructions.

An aspect of the example embodiment is related to the use of computer system 300 for selectively routing a transaction from an automated banking machine based on transaction processing fees. According to an example embodiment, selectively routing a transaction from an automated banking machine based on transaction processing fees is provided by computer system 300 in response to processor 304 executing one or more sequences of one or more instructions contained in main memory 306. Such instructions may be read into main memory 306 from another computer-readable medium, such as storage device 310. Execution of the sequence of instructions contained in main memory 306 causes processor 304 to perform the process steps described herein. One or more processors in a multi-processing arrangement may also be employed to execute the sequences of instructions contained in main memory 306. In alternative embodiments, hard-wired circuitry may be used in place of or in combination with software instructions to implement an example embodiment. Thus, embodiments described herein are not limited to any specific combination of hardware circuitry and software.

The term “computer-readable medium” as used herein refers to any medium that participates in providing instructions to processor 304 for execution. Such a medium may take many forms, including but not limited to non-volatile media and volatile media. Non-volatile media include for example optical or magnetic disks, such as storage device 310. Volatile media include dynamic memory such as main memory 306. Common forms of computer-readable media include for example floppy disk, a flexible disk, hard disk, magnetic cards, paper tape, any other physical medium with patterns of holes, a RAM, a PROM, an EPROM, a FLASHPROM, CD, DVD or any other memory chip or cartridge, or any other medium from which a computer can read.

Computer system 300 also includes a communication interface 318 coupled to bus 302. Communication interface 318 provides a two-way data communication coupling computer system 300 to a network link 320 that is connected to a local network 14 and a transaction network (or a plurality of transaction networks) 18. In particular embodiments, multiple communication interfaces 318 may be employed for communicating with local network 14 (and ATM 12) and transaction network (or plurality of transaction networks) 18 (and Transaction Hosts 330 and 332 which may correspond to Financial Transaction Authorization Systems 20 and 22 respectively).

For example, communication interface 318 may be a local area network (LAN) card to provide a data communication connection to a compatible LAN. As another example, communication interface 318 may be an integrated services digital network (ISDN) card or a modem to provide a data communication connection to a corresponding type of telephone line. Wireless links may also be implemented. In any such implementation, communication interface 318 sends and receives electrical, electromagnetic, or optical signals that carry digital data streams representing various types of information. In an example embodiment, communication interface 318 provides data communications through the worldwide packet data communication network, now commonly referred to as the “Internet”.

In view of the foregoing structural and functional features described above, a methodology 400 in accordance with an example embodiment will be better appreciated with reference to FIG. 4. While, for purposes of simplicity of explanation, the methodology 400 of FIG. 4 is shown and described as executing serially, it is to be understood and appreciated that the example embodiment is not limited by the illustrated order, as some aspects could occur in different orders and/or concurrently with other aspects from that shown and described herein. Moreover, not all illustrated features may be required to implement a methodology in accordance with an aspect of an example embodiment. The methodology described herein is suitably adapted to be implemented in hardware, software when executed by a processor, or a combination thereof. For example methodology 400 may be implemented by routing computer 16 (FIG. 1) and/or processor 304 (FIG. 3).

At 402, data representative of a requested transaction associated with a financial account associated with a user operating an automated banking machine is received from the automated banking machine. The data may comprise data obtained by a card reader from a card associated with a user and/or wirelessly from a wireless device (such as a mobile device, RFID tag, or other suitable wireless device) associated with the user. The data may comprise financial account data or data useful for obtaining financial account data. The transaction request may be for any type of financial transaction such as a deposit or withdrawal (which may include a purchase made using a financial account at a point of sale device) and may employ checks, cash, or other financial instruments.

At 404, transaction processing fees are determined for the requested transaction. The fees may be determined for a plurality of financial authorization systems (hosts) that may be associated with a plurality of transaction networks.

At 406, one of the plurality of remote financial transaction authorization systems is selected for the transaction. The selection of a remote financial transaction systems can be based at least in part on having the lowest (or no) transaction processing fee for the requested transaction.

Optionally, the method may further include communicating with the automated banking system and the selected one of the plurality of remote financial transaction systems to perform the requested transaction. Particular embodiments may further comprise determining from the data representative of a requested transaction an account number for the financial account and institution data corresponding to a financial institution holding the financial account. The selection of the selected one of the plurality of remote financial transaction authorization systems for the transaction, at 406, can be based at least in part on the institution data.

In an example embodiment, multiple transactions may be performed that involve multiple financial transaction systems. For example, a first transaction request may be routed to a first financial transaction system that can authorize the first transaction for the lowest (or no) fee, and a second transaction request may be routed to a second financial transaction system that can authorize the second transaction for the lowest (or no) fee.

Described above are example embodiments. It is, of course, not possible to describe every conceivable combination of components or methodologies, but one of ordinary skill in the art will recognize that many further combinations and permutations of the example embodiments are possible. Accordingly, this application is intended to embrace all such alterations, modifications and variations that fall within the spirit and scope of the appended claims interpreted in accordance with the breadth to which they are fairly, legally and equitably entitled.

1. An apparatus, comprising:
a routing computer operable to communicate with an automated banking machine and with a plurality of remote financial transaction authorization systems;
wherein the routing computer is operable to receive data representative of a requested transaction associated with a financial account associated with a user operating the automated banking machine;
wherein the routing computer is operable to determine a transaction processing fee for the requested transaction for the plurality of remote financial transaction authorization systems;
wherein the routing computer is operable to select a selected one of the plurality of remote financial transaction authorization systems for the transaction; and
wherein the selected one of the plurality of remote financial transaction systems is selected based on having the lowest transaction processing fee for the requested transaction.

2. The apparatus set forth in claim 1, wherein the routing computer is operable to communicate with the automated banking machine and the selected one of the plurality of remote financial transaction systems to perform the requested transaction.

3. The apparatus set forth in claim 1, wherein the selected one of the plurality of remote financial transaction systems does not assess a transaction fee for the requested transaction.

4. The apparatus set forth in claim 1, wherein the data representative of a requested transaction associated with a financial account comprises an account number.

5. The apparatus set forth in claim 1, wherein the requested transaction is for a cash withdrawal; and
wherein the routing computer is operable to communicate with the automated banking system and the selected one of the plurality of remote financial transaction systems to authorize the cash withdrawal.

6. The apparatus set forth in claim 1 wherein the data representative of a requested transactions comprises data representative of a check cashing transaction;
wherein the data representative of the check cashing transaction includes a check amount;
wherein the routing computer is operable to communicate with the automated banking system and the selected one of the plurality of remote financial transaction systems to cause the financial account to be credited with the check amount.

7. The apparatus set forth in claim 1, wherein the routing computer is operable to determine from the data representative of a requested transaction an account number for the financial account;
determine institution data corresponding to a financial institution holding the financial account; and
wherein the selection of the selected one of the plurality of remote financial transaction authorization systems for the transaction is based at least in part on the institution data.

8. The apparatus set forth in claim 1, wherein the routing computer is operable to generate messages corresponding to financial transaction messages associated with the requested transaction.

9. The apparatus set forth in claim 1,
wherein the routing computer is operable to receive data representative of a second requested transaction associated with a second financial account associated with a second user operating the automated banking machine;
wherein the routing computer is operable to determine a transaction processing fee for the second requested transaction for the plurality of remote financial transaction authorization systems;
wherein the routing computer is operable to select a second of the plurality of remote financial transaction authorization systems for the second requested transaction; and
wherein the selected second of the plurality of remote financial transaction systems is selected based on having the lowest transaction processing fee for the second requested transaction.

10. The apparatus set forth in claim 9, wherein the routing computer is operable to determine from the data representative of a requested transaction an account number for the financial account;
determine institution data corresponding to a financial institution holding the financial account;
wherein the selection of the selected one of the plurality of remote financial transaction authorization systems for the transaction is based at least in part on the institution data;
wherein the routing computer is operable to determine from the data representative of a second requested transaction a second account number for the second financial account;
determine institution data corresponding to a second financial institution holding the second financial account; and
wherein the selection of the selected second of the plurality of remote financial transaction authorization systems for the transaction is based at least in part on the institution data.

11. The apparatus set forth in claim 9, wherein the first requested transaction includes dispensing a first amount of cash having a first value;
wherein the second requested transaction includes dispensing a second amount of cash having a second value;
wherein the first selected financial transaction system is operable to cause the first financial account to be assessed the first value; and
wherein the second selected financial transaction system is operable to cause the second financial account to be assessed the second value.

12. The apparatus set forth in claim 1 wherein the receive data representative of a requested transactions comprises data representative of a cash deposit transaction;
wherein the data representative of the check cashing transaction includes an amount;
wherein the routing computer is operable to communicate with the automated banking system and the selected one of the plurality of remote financial transaction systems to cause the financial account to be credited with the amount.

13. An apparatus, comprising:
a routing computer operable to communicate with an automated banking machine and with a plurality of remote financial transaction authorization systems;
wherein the routing computer is operable to receive data representative of a requested transaction associated with a financial account associated with a user operating the automated banking machine;
wherein the routing computer is operable to determine a transaction processing fee for the requested transaction for the plurality of remote financial transaction authorization systems;
wherein the routing computer is operable to select a selected one of the plurality of remote financial transaction authorization systems for the transaction; and
wherein the selected one of the plurality of remote financial transaction systems is selected based on performing the transaction without assessing a transaction processing fee.

14. The apparatus set forth in claim 13, wherein the computer system is operable to communicate with the automated banking system and the selected one of the plurality of remote financial transaction systems to perform the requested transaction.

15. Logic encoded in a tangible, non-transitory computer readable medium of instructions for execution by a processor, and when executed operable to:
communicate with an automated banking machine and with a plurality of remote financial transaction authorization systems;
receive data representative of a requested transaction associated with a financial account associated with a user operating the automated banking machine;
determine a transaction processing fee for the requested transaction for the plurality of remote financial transaction authorization systems; and
select a selected one of the plurality of remote financial transaction authorization systems for the transaction;
wherein the selected one of the plurality of remote financial transaction systems is selected based on having the lowest transaction processing fee for the requested transaction.

16. The logic set forth in claim 15, further operable to communicate with the automated banking system and the selected one of the plurality of remote financial transaction systems to perform the requested transaction.

17. The logic set forth in claim 15, wherein the selected one of the plurality of remote financial transaction systems does not assess a transaction fee for the requested transaction

18. The logic set forth in claim 15, further operable to:
determine from the data representative of a requested transaction an account number for the financial account; and
determine institution data corresponding to a financial institution holding the financial account;
wherein the selection of the selected one of the plurality of remote financial transaction authorization systems for the transaction is based at least in part on the institution data.

19. The logic set forth in claim, further operable to:
receive data representative of a second requested transaction associated with a second financial account associated with a second user operating the automated banking machine;
determine a transaction processing fee for the second requested transaction for the plurality of remote financial transaction authorization systems; and
select a second of the plurality of remote financial transaction authorization systems for the transaction;
wherein the selected second of the plurality of remote financial transaction systems is selected based on having the lowest transaction processing fee for the second requested transaction.

20. The logic set forth in claim 19, further operable to:
determine from the data representative of a requested transaction an account number for the financial account;
determine institution data corresponding to a financial institution holding the financial account;
wherein the selection of the selected one of the plurality of remote financial transaction authorization systems for the transaction is based at least in part on the institution data;
determine from the data representative of a second requested transaction a second account number for the second financial account; and
determine institution data corresponding to a second financial institution holding the second financial account;
wherein the selection of the selected second of the plurality of remote financial transaction authorization systems for the transaction is based at least in part on the institution data.
